(19) United States
(12) Patent Application Publication
(10) Pub. No.: US 2025/0056700 A1
(43) Pub. Date: Feb. 13, 2025

(54) SMART LIGHTING AND APPLIANCE CONTROL SYSTEM WITH LOCATION AND CALENDAR AWARENESS

(71) Applicant: Lighting & Supplies, Inc., Brooklyn, NY (US)

(72) Inventor: Mordechai Kohn, Brooklyn, NY (US)

(21) Appl. No.: 18/781,218

(22) Filed: Jul. 23, 2024

Related U.S. Application Data
(60) Provisional application No. 63/531,495, filed on Aug. 8, 2023.

(51) Int. Cl. H05B 47/165; G05B 19/042

(52) U.S. Cl. CPC H05B 47/165; G05B 19/042; G05B 2219/25011

(57) ABSTRACT

A Smart Lighting and Home Automation System and methods for controlling the illumination and related electrical devices located in a space through the use of Smart hardware devices including lamps, lights, sensors, switches and dimmers, and a cellular smartphone or remote computer running a software application to control the Smart devices. The Smart Lighting and Home Automation System, methods, processes, electrical hardware devices, and software application are intended to overcome religious prohibitions observed during the Shabbat and other holiday events under Orthodox Jewish law. The Smart Lighting and Home Automation System allows a user to interface directly with the setup of Smart Devices including adding, editing, and deleting the dates, times, and actions of default Shabbat schedules and other special Jewish holiday events before and after, and optionally during such events while adhering to Jewish customs and laws.

### CROSS-REFERENCE TO RELATED APPLICATION

The present non-provisional patent application claims the benefit of and priority to U.S. Provisional Patent Application No. 63/531,495, filed Aug. 8, 2023, by Mordechai Kohn, and entitled “SMART LIGHTING AND APPLIANCE CONTROL SYSTEM WITH LOCATION AND CALENDAR AWARENESS,” the entire contents of which are incorporated herein by reference.

### FIELD OF THE INVENTION

This invention relates to a computer-controlled automation system, in particular, the present disclosed subject matter is directed to a method and apparatus for enabling Jewish people to control building and household lighting during religious holidays.

### BACKGROUND OF THE INVENTION

By way of background and has been described in prior publications, Jewish people are commanded under Jewish law to refrain from 39 categories of labor on the Sabbath, holidays, and festivals, i.e., Jewish events. These rules, the timing of the holidays, and the rules governing the interplay there between may be found in the Jewish Law, or Halakhah. The Halakhah includes the Tanakh (i.e., Torah, Nevi'im, and Ktuvim) and Talmudic Literature (which includes the Mishnah, Tosefta, Jerusalem Talmud and Babylonian Talmud), each of which are herein incorporated by reference. Flipping on or off a common wall light switch constitutes a prohibited act under the category of lighting and extinguishing a fire. Therefore, Jewish people take extreme care not to accidentally change the state of a light by inadvertently bumping the switch. In addition, there is a concern where small children or non-Jewish people change the desired state of the light during a holiday unaware that a Jewish person cannot return the light to its previous state or request another person to do so.

Jewish people go to great lengths in order to prevent or at least mitigate these concerns by painstakingly taping down numerous light switches just prior to a holiday. An alternate solution offered by the current state of the art is an external magnetic light switch cover that is manually positioned over the switch face plate to create a physical barrier to the on/off switch.

Since securing the state of the lights is usually one of the last tasks completed just moments before the start of a holiday, these time-consuming methods produce stress as the person searches for the tape or switch covers and rushes to physically secure the light switch from manipulation during the holiday.

Shabbat observant Jews may not turn electrical switches or electrical devices and appliances on or off during the Shabbat, which is from sundown on Friday until after dark on the following Saturday. Further, because Jewish people are not allowed to change the state of the lights when not being used during the Sabbath an enormous amount of energy and money is wasted. Shabbat observant Jews may not turn electrical switches or electrical devices and appliances on or off during the Shabbat, which is from sundown on Friday until after dark on the following Saturday. This can force a Shabbat observant family to leave on some lights and electrical devices like televisions and radios during this period that can be disturbing to some family members and in particular those wishing to rest, pray, retire or go to sleep.

Previously, a mechanical timer with a little clock dial for each separate lamp, crock pot, or other electrical appliance was used to turn all of these devices on and off. The automatic electric timer is a modern device that permits the control of illumination or electrical devices under these circumstances and must be set up prior to Shabbat or after the Shabbat ends, and cannot be adjusted during that day for whatever reason without violating religious prohibitions. The difficulty in maintaining the schedule for these clocks is due to two factors. First, Shabbos, as well as Yom Tov, starts at Sundown. Second, the Jewish calendar is based on the lunar cycle and, therefore, Jewish Holidays come out on different English dates as well as different days of the week. Consequently, schedules are constantly changing and the time clocks always have to be reset and adjusted.

There is a light fixture that has been in the market called the Kosher Lamp that is distributed by Kosher Innovations and is disclosed under U.S. Patent Publication No. 2005/0036322A1 entitled, “Lamp”, invented by Samuel C. Veffer and published in Feb. 17, 2005. It is for a standalone lighting fixture that accepts a standard light bulb or compact fluorescent lamp that remains on at all times. Light is released or blocked from entering a space or room by a manually rotating an opaque light blocking cylinder cover with a single small opening that revolves around the light source for the control of illumination of the light source.

There are some disadvantages to the Kosher Lamp product. It is not bright enough for certain applications, because only a small portion of light exits from the small opening in a limited projection of light. This becomes a problem putting eye strain on users of this lamp when used for reading due to the lack of its brightness. In addition, the Kosher Lamp has to be used on a flat table top and cannot be placed on a wall or a ceiling allowing for multiple mounting positions of the lamp for a wider projection of the light from the lamp. The light beam coverage is limited and is difficult to place light in many directions at the same time.

U.S. Pat. No. 9,541,262 entitled, “Shabbat Bulb”, invented by Kohn et al. and issued in Jan. 10, 2017 and U.S. Pat. No. 10,203,073 entitled, “Shabbat Bulb with gear-controlled blackout mechanism, also invented by Kohn et al. and issued in Feb. 12, 2019 overcome the drawbacks of the Kosher Lamp product and both provide many other advantages and improvements.

These two Kohn et al. patents relate to a combination light source and light interrupter for passing or blocking the flow of light from the light source into a space or room that would otherwise be illuminated by the light source. The light interrupter is portable and may be removed from the light source at will. The separate and removable light interrupter is essentially a blackout shutter mechanism that attaches directly to the light source, and it does not directly touch any part of the light source or any of its associated electrical parts. The light source remains on at all times and the blackout shutter mechanism is manually operated by a user to pass or to block out the light from the light source into a space or room, and helps reduce the inconvenience caused by a light fixture that remains electrically turned on by providing a combination light source and light interrupter that is suitable for reading or other purposes. The Shabbos bulbs are easily and conveniently adapted to selectively provide light in any lighting fixture or light socket that will accept the combination light source and light interrupter blackout shutter mechanism. In operation, the blackout arm may be grasped by a user and manually positioned with respect to the light source either by a sliding lever or a rotating knob such that the opening in the lamp may be partially or fully aligned with the aperture in the blackout mechanism. In this way, a selective amount of light may be emitted with the light source illuminated. Further, with the light illuminated, heat is vented through the aperture provided in the various embodiments of the portable blackout mechanisms. The amount of light exiting from the light source is dependent on the degree of overlap of the opening in the blackout mechanism and the aperture, which is selected by a user moving the blackout arm into the light beam of the light source.

Observant Jewish people are not permitted to physically handle or move an electric light source or light bulb during Shabbat. There becomes a need for a Smart Lighting System for use with Smart lamps and Smart switches, Smart dimmers, Smart sensors, and other Smart devices that can be easily programmed before the Shabbat. The Shabbat bulbs disclosed in Kohn et al. patents can be made with dimmable internal drivers to work with this Smart Lighting System using a Smart dimming switch, so that an observant Jew may still be able to use the manual shutter even during Shabbat without breaking any Jewish laws. The Shabbat bulbs in Kohn et al. can also be made with its own internally dedicated wireless receiver to be controlled directly by a remote controller running a custom software application or cellular smartphone app. Thus, these patented Shabbat lamps may be operated by Shabbat observant Jews using the Smart Lighting System of the present invention.

Eventually, home automation systems were developed which allowed centralized scheduling of the various lights and appliances in the home either using a timed controller or a computer. On/off command signals are sent out to control each appliance via the home wiring system. However, all of these systems have two major drawbacks as they relate to scheduling for Shabbos and Yom Tov. First, they are based on the English calendar, and second, schedules still had to be adjusted manually since the times would change from week to week.

All these problems were solved in a home automation system produced by the same inventor of this application in which Torah and technology were combined. The schedule for turning on/off of all the electrical devices is generated according to Jewish calendar and Jewish religious activities combined with the particular life style of the family. The system automatically generates a new schedule weekly and knows when Jewish Holidays are coming and generates the appropriate schedule for them. The user does not have to make any adjustments from week to week. The automation system, however, does allow the user to set special schedules for particular activities to override the regular schedule so that individual needs might be considered and flexibly incorporated. However, the automation system still needs some improvements.

Sunshine Lighting, Inc. is introducing a new software application that will run on cellular smartphones or on a dedicated remote controller under the SUNLITE® brand name called SmartHome™ for use by observant Jews for Smart Lighting Control for SUNLITE® Products. Other possible trademarks for the new APP besides SmartHome™ may be KosherHome™ or SunliteHome™, or any similarity to these marks may be used in the final Smart Lighting System. It will be used to control many types of Smart Devices including lamps, light fixtures, electric switches, dimmers, etc. The Smart hardware devices will be mainly SUNLITE branded products that are private labeled from manufacturers of the Smart dimmers, lamps, light fixtures, switches, etc., but the SmartHome™ Home Automation Program APP will also work with many other Smart devices are made by other suppliers that can be easily added to the database of the software application.

One partner in China working with Sunshine Lighting, Inc. on this venture is Xiamen Tenia Lighting and Electrical Co. Ltd. manufacturing and supplying their Wi-Fi Smart Switches and Smart Dimmers. The Smart devices can be wirelessly controlled using primarily Wi-Fi, but other wireless protocols can be used in this platform including BT or Bluetooth Mesh, DMX512, DALI, Zigbee, Nuwave, Z-Switch, LTE, 5G, etc. among many others. The software application will be written by TUYA under a joint venture exclusively designed and developed for and owned by Sunshine Lighting, Inc. TUYA is a well-known company with a cellular smartphone application that can control many Smart devices in use world wide today. They are based out of Hangzhou China and offer value-added Sales Differentiation, Programming and Cloud based skills, and WWGA Certification of the SmartHome™ Home Automation Program APP belonging to Sunshine Lighting, Inc. for Smart Lighting control.

There are some patents already out there that do similar control of Smart devices during the Jewish Shabbath. They include, U.S. Pat. Nos. 6,473,661, 9,024,545 and 10,564,618, but the SUNLITE® brand SmartHome™ system is better and different.

U.S. Pat. No. 6,473,661 issued to Wollner on Oct. 29, 2002 titled, “Home Automation System” discloses a home automation system for automatically controlling the electric lights and appliances in a Jewish family's home or Jewish institution. The system is preset to generate regular schedules for Shabbat and Jewish Holidays events based on the Jewish calendar and may also generate regular weekday scheduled events. Special schedules such as vacation mode, guest mode, summer mode and the like may be added and adjusted by the user a well. The special schedules or modes may be manually activated by a mechanical device outside the computer. Updated schedules are reported to a remotely located monitoring system. Some rooms may be bypassed by the regular schedule if desired. Power fail recovery and automatic atomic clock synchronization are also provided in the system.

U.S. Pat. No. 9,024,545 issued to Bloch et al. on May 5, 2015 titled, “Method and Apparatus for a geographically determined Jewish religious clock and electrical device combination with holiday and preference modes” discloses an independently functioning or centrally controlled wall light switch configured to operate in normal mode and a Jewish holiday mode, wherein the state of the light is fixed, regardless of the user's physical manipulation of the light switch. The control system automatically activates holiday mode by combining a geographically determined Jewish religious clock executed by software and hardware that utilizes the current time, date, and geographical location of the apparatus in accordance with the Jewish definition of time and laws for calculating numerous religiously significant shifting daily points in time. The control system further incorporates several energy saving and preference modes by utilizing a particular day's calculated religious points in time in conjunction with holiday behavior patterns common to most Jewish families to provide the user with a greatly simplified means of programming an automatically adjusting on/off light timer and dimming overlay function during holiday mode.

U.S. Pat. No. 10,564,618 issued to Lavie on Feb. 18, 2020 titled, “Time Controlled Switch” discloses a time controlled electrical switch operable in a Sabbath state and in a working day state, comprising a switching component for selectively directing the supply of electrical power, or for selectively transmitting a logical input, to a device; a memory device in which is stored local sunset information, calendar information, and predetermined rules for initiating a state changing event relating to a Sabbath state and a working day state; a logical circuit in data communication with the switching component, and a time supplying device. The logical circuit is operable to transmit a signal to the switching component for initiating the state changing event in response to an instantaneous time indicated by the time supplying device and the stored local sunset information, calendar information, and predetermined rules.

In contrast to the three patents U.S. Pat. Nos. 6,473,661, 9,024,545 and 10,564,618 referenced above, the new and present SUNLITE® SmartHome™ system stores all data and settings on a remote cloud database through the TUYA application running either on a cellular smartphone device or on a remote controller using GPS/Geographical Halachic Zmanim data.

### SUMMARY OF THE INVENTION

The present invention is directed to improving the above home automation system. In general, the purpose for this new Smart Lighting Control System is to develop a new, Kosher, automated product that can be used for bulbs, lighting fixtures, and other devices tied to Halachic Zmanim based on a user's geographic location/zip code, utilizing the timestamp in a Wi-Fi router and TUYA cloud to keep accurate time between user device functionality. To summarize, the Halachic Zmanim database can be pulled from an Open API Github like https://github.com/KosherJava/zmanim, or from an Open API pulled from HebCal at https://www.hebcal.com/home/1663/zmanim-halachic-times-api.

The functionality of the SmartHome™ Home Automation Program APP is based on determined Zmanim and user location, through a TUYA reskinned Shabbos APP. A user can open the control panel for a Sunlite Shabbos Smart Switch, set their preferences for performance (on/off, dimming, etc.) before and after the Shabbos or Yom Tovim. Through automating the functionality, the user can maintain energy savings and better lighting features, all while maintaining a Kosher home.

The SUNLITE® SmartHome™ Home Automation Program APP operates in more or less the following manner. After opening the application, we arrive at a home display screen that always start off first in the LOGIN SCREEN prompting the user to Login or to setup a New User.

The second display screen is the VIEW/ADD DEVICE SCREEN. This screen will show all devices to be controlled that will be added or have already been added to the application remote cloud database, or the user can Add Device if No devices have been previously added. On the bottom of the Device Screen, there is a Menu of four icon buttons. Starting from the bottom left corner and moving to the right corner. The first icon is a HOME icon button to go back to the first HOME LOGIN SCREEN. The second icon is a Scene button that will allow the user to Group Devices together and allow the Groups of Devices to perform different pre-programmed canned looks or scenes based on defined times, settings, and durations. The third icon is a Smart button that connects to TUYA available features including Cloud Storage, Message Notification, or Phone Notification, etc. Lastly, the fourth icon is a Me button or User Profile page that stores entered data about the user of the custom SmartHome™ Home Automation Program APP.

Clicking on any Device added to the second VIEW/ADD DEVICE SCREEN will take the user to a third display screen linked to each particular Smart device. In this example, Dimmer1 takes the user to a DEVICE SCREEN with the Name of the Device on the Top Heading with an EDIT icon button on the top right corner and a BACK icon button on the top left corner to return to the previous VIEW/ADD DEVICE SCREEN. In this screen, Dimmer1 is shown with a Brightness adjustment slider that can be moved from 1% or lowest intensity up to 100% or full intensity. On the bottom of the Device Screen, there is also a Menu of four icons. Starting from the bottom left corner and moving right. Hitting the first POWER icon button toggles Dimmer1 from OFF to the preset Brightness level set on the adjustment slider from 1% up to 100% intensity.

The second SCHEDULE icon button will take the user to a fourth GENERAL SCHEDULE Timer setup screen that will allow general ON/OFF/DIM setting for the various Smart Devices connected to the SmartHome™ Home Automation Program APP. On the bottom of this window is an ADD button that will allow the user to add additional days and times for the particular Device selected. When done with the GENERAL SCHEDULE Timer screen, hit the top left return button to go back to the third DEVICE SCREEN for the particular Device selected for additional scheduling and settings.

The third SHABBAT icon button will take the user to a SCHEDULE OPTION 1 or a SCHEDULE OPTION 2 screen. These two screens allow for additional detailed timer programming schedules of Shabbat and other Jewish Holidays and Special Events. The user can select the Auto Shabbat Schedule in which case all timer schedules including Candle lighting dates and times automatically from the GPS/Geographical Halachic Zmanim data websites based on the user's location as entered in the Smart TUYA setup icon button or in the Me profile setup icon button both in the second display screen bottom menu icon buttons described earlier. In other words, When the Auto Shabbat Schedule icon button is selected to ON, the times are automatically set by the Zmanim API based on the geographical location of the user and zip code. In this enabled ON setting, the GENERAL SCHEDULE Timer is disabled and the subsequent Shabbat and other Jewish holiday schedules can be Viewed and Edited or left to take the Zmanim API defaults. When the Auto Shabbat Schedule is disabled or set to OFF, only the GENERAL SCHEDULE Timer settings are Active, i.e., all Jewish preset schedules are disabled.

SCHEDULE OPTION 1 gives the user access to an Auto Shabbat Scheduling on/off option, and a Disable Device During Shabbat on/off option to prevent accidentally turning on/off a programmed Device. In this window, the user can also View/Edit a Shabbat Schedule; a Rosh Hashana Schedule; a Yom Kippur Schedule; a Sukkot Schedule; a Pesach Schedule; and a Shavuot Schedule. SCHEDULE OPTION 2 is similar to SCHEDULE OPTION 1 with additional scheduling options. Like before, SCHEDULE OPTION 2 gives the user access to an Auto Shabbat Schedule option for on/off, and a Disable Device During Shabbat option for on/off. In this window, the user can View/Edit a Shabbat Schedule; a Rosh Hashana Schedule; a Yom Kippur Schedule; a Sukkot Schedule; a Shemini Atzeret Schedule; a Pesach (1^{st} Days) Schedule; a Pesach (2^{nd} Days) Schedule; and a Shavuot Schedule.

When a user selects the Shabbat Schedule View/Edit selection button on either the SHABBAT SCHEDULE OPTION 1 or the SHABBAT SCHEDULE OPTION 2 display screens, the user will be taken to an EDITABLE SCREEN for that particular Device Shabbat Schedule. From the Zmanim API websites, the data for Occasions or Events like Parshat Shemot for example, the Date, and the actual Candle Lighting Start and End times are displayed, and the user can then add start times, end times, and actions for each particular Device or Group of Devices in EDIT display screens in preset times by 15-minute increments with editable times based on default Candle Lighting times, or based on editable times independent of the default Candle Lighting times, or based on default Event end times like Shabbat End times for example.

The same features are also available for the other Jewish holidays and special events with editable days and times besides the default Candle Lighting, independent of the Candle Lighting times, and default Event end times automatically set by the Zmanim API websites when the Auto Shabbat Schedule is selected in either SHABBAT SCHEDULE OPTION 1 or SHABBAT SCHEDULE OPTION 2.

Some additional features may include: Normal Weekday programming functions including ON/OFF; Dimming from 1% to 100%; Selectable Color-Tuning at 2700K, 3000K, 3500K, 4000K, and 5000K color temperatures; and Voice Command Control and AI interfacing with Amazon Alexa, Google Assistant, AliGenie, DuerOS, Tencent Xiaowei, Tencent Dingdan, etc. For Shabbos/Yom Tov function, the SmartHome™ Home Automation Program APP will automatically link to Zmanim and at Shabbat Candle Lighting, a user can setup and plan different scenes for example, to dim light to a user determined percentage or to remain full ON at 100%, and adjust the color temperature, turn OFF lights after a user determined time in hours and minutes, and then turn back ON the lights at a user determined time of the day, etc. Lastly, other capabilities of the SmartHome™ Home Automation Program APP program and may include synching with human Biorhythms including Circadian related lighting adjustments for sleeping and waking; APP data memory retention during an emergency power failure condition and Power-on behavior, Do-Not-Disturb settings, and Cycle and Zmanim Timings.

According to the present invention, a home automation system comprises a plurality of switches for turning on/off each of the devices, a computer having means for generating a regular schedule of an on/off time for each of the devices and means for generating a special schedule of an on/off time for at least one of the devices. A user interface or a mechanical means is provided for manually selecting between the regular schedule and special schedules for the devices. The switches are automatically activated according to the selected schedule.

The regular schedule is set according to Jewish calendar and rules on Jewish religious activities while the special schedule may be set according to length of day time in different seasons or according to needs of the user for some particular activities.

The regular schedule and special schedules may be updated at a preset interval and the updated schedules may be reported to a monitoring system remotely located from the home.

The system may further comprise means for automatically synchronizing the clock in the computer with the National Bureau of Standards atomic clock.

The features and advantages of the present invention may be clearer from the following detailed description in reference to the accompanying drawings in which:

In one aspect, the apparatus and methods described herein provide means for obtaining date, time and geographic location data and combining it with electronic and/or mechanical devices to enable a control system to operate the apparatus in accordance with Jewish law by utilizing the resulting religious reference times that are calculated from the sun's and moon's relationship to the device's specific geographic location.

In one embodiment of such an apparatus, an electrical switch provides a means of selecting between a normal mode and a holiday mode. If the holiday mode is activated, the control system overrides normal mode functionality. At the onset of the holiday period the control system fixes the state of the switch in its current on/off state, maintaining that state regardless of the user's physical manipulation of the light switch. In another aspect, the ability to select modes is provided by means of a button to activate a control system for automatically initiating the holiday mode at the beginning of a Jewish holiday and for automatically deactivating the holiday mode at the end of a Jewish holiday.

In a further aspect, techniques may be employed to store a holiday calendar and detect local date, time, and daylight conditions within the apparatus, to facilitate the above functions.

These and other aspects, features, and advantages of the present invention will become more readily apparent to those skilled in the art from reading the following detailed description and on reviewing the following attached drawings referenced below on the preferred embodiments.

### BRIEF DESCRIPTION OF THE DRAWINGS

The preferred embodiments of the invention will be described in conjunction with the appended drawings provided to illustrate and not to the limit the invention, where like designations denote like elements and in which:

FIG. 1A shows in basic terms what Tuya, Inc. does in helping to create the SmartHome™ Home Automation Program APP for Sunshine Lighting, Inc.

FIG. 1B shows some TUYA Coding parameters and values that may be used in the SmartHome™ Home Automation Program APP.

FIG. 2A shows the initial HOME Login Screen of the SmartHome™ Home Automation Program APP.

FIG. 2B shows the View/Add Device Screen of the SmartHome™ Home Automation Program APP.

FIG. 2C shows the Device Screen of the selected device or group of devices of the SmartHome™ Home Automation Program APP.

FIG. 2D shows the General Schedule Timer setup screen of the SmartHome™ Home Automation Program APP.

FIG. 2E shows the Shabbat Schedule Option 1 screen of the SmartHome™ Home Automation Program APP.

FIG. 2F shows the Date Selectable Shabbat Schedule screen of the SmartHome™ Home Automation Program APP for the Shabbat Schedule Option 1 or the Shabbat Schedule Option 2 when selected.

FIG. 2G shows the Editable Screen for the Shabbat Schedule of the SmartHome™Home Automation Program APP for the Shabbat Schedule Option 1 or the Shabbat Schedule Option 2 when selected.

FIG. 2H shows the Edit screen for the Time from Candle Lighting with 15-minute increment preset times based on the Candle Lighting time of the SmartHome™ Home Automation Program APP for the Shabbat Schedule Option 1 or the Shabbat Schedule Option 2 when selected.

FIG. 2I shows the independent Edit Time screen of the SmartHome™ Home Automation Program APP for the Shabbat Schedule Option 1 or the Shabbat Schedule Option 2 when selected.

FIG. 2J shows the Edit screen for the Time from Shabbat End with 15-minute increment preset times based on the event end time of the SmartHome™ Home Automation Program APP for the Shabbat Schedule Option 1 or the Shabbat Schedule Option 2 when selected.

FIG. 2K shows the Shabbat Schedule Option 2 screen of the SmartHome™ Home Automation Program APP.

FIG. 2L shows the Sukkot Schedule Day 1 Option 1 screen of the SmartHome™ Home Automation Program APP for the Shabbat Schedule Option 2.

FIG. 2M shows the Sukkot Schedule Day 2 Option 1 screen of the SmartHome™ Home Automation Program APP for the Shabbat Schedule Option 2.

FIG. 2N shows the Shmini Atzeret Option 1 screen of the SmartHome™ Home Automation Program APP for the Shabbat Schedule Option 2.

FIG. 2O shows the Simchat Torah Option 1 screen of the SmartHome™ Home Automation Program APP for the Shabbat Schedule Option 2.

FIG. 2P shows the Sukkot Schedule Day 1 Option 2 screen of the SmartHome™ Home Automation Program APP for the Shabbat Schedule Option 2.

FIG. 2Q shows the Sukkot Schedule Day 2 Option 2 screen of the SmartHome™ Home Automation Program APP for the Shabbat Schedule Option 2.

FIG. 2R shows an additional or alternate screen similar to the Device Screen of FIG. 2C that may be used in the SmartHome™ Home Automation Program APP.

FIG. 3A shows the Mode Selection Process Flowchart for FIG. 2A and FIG. 2B of the SmartHome™ Home Automation Program APP.

FIG. 3B shows the Mode Selection Process Flowchart for FIG. 2C of the SmartHome™ Home Automation Program APP for the Shabbat Schedule Option 1 or the Shabbat Schedule Option 2 when selected.

FIG. 3C shows the Mode Selection Process Flowchart for FIG. 2D and FIG. 2E of the SmartHome™ Home Automation Program APP for the Shabbat Schedule Option 1.

FIG. 3D shows the Mode Selection Process Flowchart for FIGS. 2F to 2J for the setting of Shabbat dates and times on the SmartHome™ Home Automation Program APP for the Shabbat Schedule Option 1.

FIG. 3E shows the Mode Selection Process Flowchart for FIGS. 2F to 2J for the similar setting of Rosh Hashana dates and times on the SmartHome™ Home Automation Program APP for the Shabbat Schedule Option 1.

FIG. 3F shows the Mode Selection Process Flowchart for FIGS. 2F to 2J for the similar setting of Yom Kippur dates and times on the SmartHome™ Home Automation Program APP for the Shabbat Schedule Option 1.

FIG. 3G shows the Mode Selection Process Flowchart for FIGS. 2F to 2J for the similar setting of Sukkot dates and times on the SmartHome™ Home Automation Program APP for the Shabbat Schedule Option 1.

FIG. 3H shows the Mode Selection Process Flowchart for FIGS. 2F to 2J for the similar setting of Pesach dates and times on the SmartHome™ Home Automation Program APP for the Shabbat Schedule Option 1.

FIG. 3I shows the Mode Selection Process Flowchart for FIGS. 2F to 2J for the similar setting of Shavuot dates and times on the SmartHome™ Home Automation Program APP for the Shabbat Schedule Option 1.

FIG. 3J shows the Mode Selection Process Flowchart for FIG. 2D and FIG. 2K of the SmartHome™ Home Automation Program APP for the Shabbat Schedule Option 2.

FIG. 3K shows the Mode Selection Process Flowchart for FIGS. 2F to 2J for the setting of Shabbat dates and times on the SmartHome™ Home Automation Program APP for the Shabbat Schedule Option 2.

FIG. 3L shows the Mode Selection Process Flowchart for FIGS. 2F to 2J for the similar setting of Rosh Hashana dates and times on the SmartHome™ Home Automation Program APP for the Shabbat Schedule Option 2.

FIG. 3M shows the Mode Selection Process Flowchart for FIGS. 2F to 2J for the similar setting of Yom Kippur dates and times on the SmartHome™ Home Automation Program APP for the Shabbat Schedule Option 2.

FIG. 3N shows the Mode Selection Process Flowchart for Option 1 FIGS. 2L to FIG. 2O or Option 2 FIG. 2P and FIG. 2Q for the setting of Sukkot dates and times on the SmartHome™ Home Automation Program APP for the Shabbat Schedule Option 2.

FIG. 3O shows the Mode Selection Process Flowchart for Option 1 FIGS. 2F to 2J for the similar setting of Shemini Atzeret dates and times under FIG. 2N including Simchat Torah under FIG. 2O on the SmartHome™ Home Automation Program APP for the Shabbat Schedule Option 2.

FIG. 3P shows the Mode Selection Process Flowchart for FIGS. 2F to 2J for the similar setting of Pesach First Days schedule dates and times on the SmartHome™ Home Automation Program APP for the Shabbat Schedule Option 2.

FIG. 3Q shows the Mode Selection Process Flowchart for FIGS. 2F to 2J for the similar setting of Pesach Second Days schedule dates and times on the SmartHome™ Home Automation Program APP for the Shabbat Schedule Option 2.

FIG. 3R shows the Mode Selection Process Flowchart for FIGS. 2F to 2J for the similar setting of Shavuot dates and times on the SmartHome™ Home Automation Program APP for the Shabbat Schedule Option 2.

### DETAILED DESCRIPTION OF PREFERRED EMBODIMENTS OF THE INVENTION

As required by Jewish religious rules, electric lights and other appliances are not allowed to be manually turned on or off on Shabbos or Jewish Holidays. This makes it a big inconvenience to the observant Jew since there are so many lights and other electric appliances which need to be used on these days in the typical Jewish home. A home automation system that is capable of automatically scheduling the control of these lights and appliances in accordance with Jewish law is in high demand.

The development of computer technology makes it possible for a typical family, with the help of a particular program running on a personal computer, to automatically control all these lights and electrical appliances for every scheduled holiday or religious activity. The schedule shall be set by the Jewish calendar, which is very different from a regular calendar. The on/off commands may be sent to each of plural switches through the existing electrical wires in the home using X-10 technology or wirelessly. The X-10 hard-wired power and communications link between the personal computer or table-top controller for the Smart devices of the present invention continues to work well for those conventional users that do not use Smartphones are other Smart devices on a regular and daily basis. For the early adopters and high-technology audience, Smartphones and Smart device users prefer to operate in a wireless environment that the present Home Automation System can easily work with both protocols.

The home automation system of the present invention comprises a personal computer, or a table-top PC controller, or a Smartphone on which an automation program is running to control the electric lights and appliances in the home on a preset schedule. The program may be written using the Visual Studio VC 6.0 or other programming language that is compiled into a Windows executable file or a Smartphone program application running on Apple IOS for Apple smart devices, or Windows Phone OS for Microsoft smart devices, or Android OS or Linux for Android smart devices, or ChromeOS (also Linux-based) for Google smart devices, etc. among many other operating systems and platforms.

The SmartHome™ Home Automation System is primarily geared towards the wireless world for communications and portability, but it should be understood that a wired version of the SmartHome™ Home Automation System may offer both capabilities albeit two or more different types of Controllers for the various Smart devices. On this note, Sunshine Lighting, Inc. is working with Tuya, Inc. on the front-end user interface and programming application for the SmartHome™ Home Automation Program APP.

Tuya, Inc. now Tuya Smart is a leading technology company focused on making our lives smarter. Tuya does this through offering a cloud platform that connects a range of devices via the IoT. By building interconnectivity standards, Tuya bridges the intelligent needs of brands, OEMs, developers, and retail chains across a broad range of smart devices and industries. The Company's platform is backed by industry-leading technology complete with rigorous data protection and security. Tuya solutions empower partners and customers by improving the value of their products while making consumers' lives more convenient through the application of technology. Through its growing commercial SaaS business, Tuya offers intelligent business solutions for a wide range of verticals. Tuya partners with leading Fortune 500 companies from around the world to make things smarter, including Philips, Schneider Electric, Lenovo and many others. As of Mar. 31, 2023, Tuya IoT Development Platform has accumulated over 782,000 registered developers from over 200 countries and regions serving more than 7,600 customers. Smart devices powered by Tuya are currently available in approximately 120,000 stores all over the world. Tuya is traded on the NYSE under TUYA. For this reason, Sunshine Lighting, Inc. decided to work with Tuya, Inc. on this new SmartHome™ Home Automation Program APP.

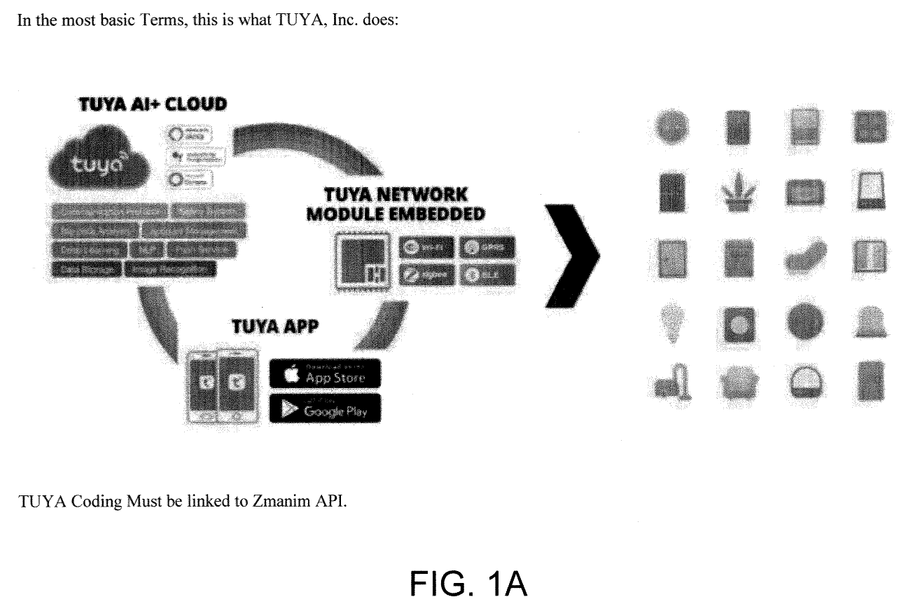

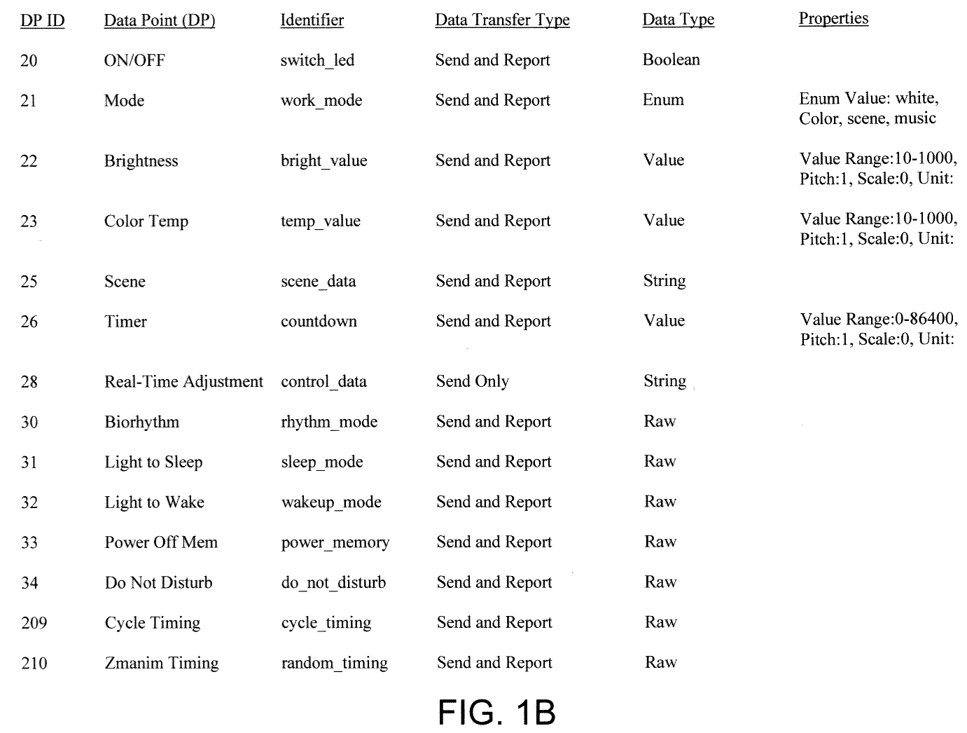

FIG. 1A shows in basic terms what Tuya, Inc. does in helping to create the SmartHome™ Home Automation Program APP for Sunshine Lighting, Inc. Tuya creates customer APPS that can run on Google and Apple platform phones for ease of use and convenience. They can also create custom programming operating on a Tuya OS that can be embedded in networking modules and remote controllers for example, for those that do not own or use portable cellular smartphones. All networking hardware can be linked to the Tuya APP with Cloud base storage and artificial intelligence or AI to tie everything together to make our lives smarter and easier.

Tuya software engineers and programmers use embedded coding like the commands and variables that are tied into the open source Zmanim API data. FIG. 1B shows some TUYA Coding parameters and values that may be used in the SmartHome™ Home Automation Program APP.

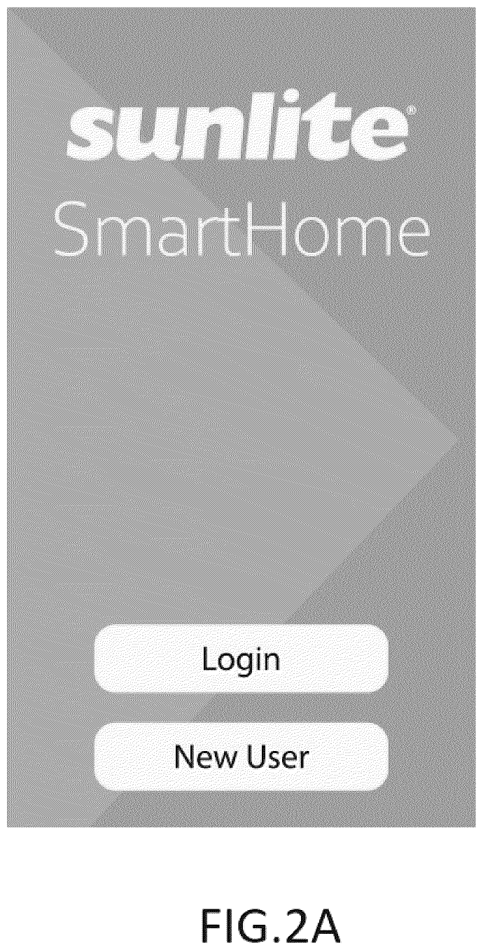

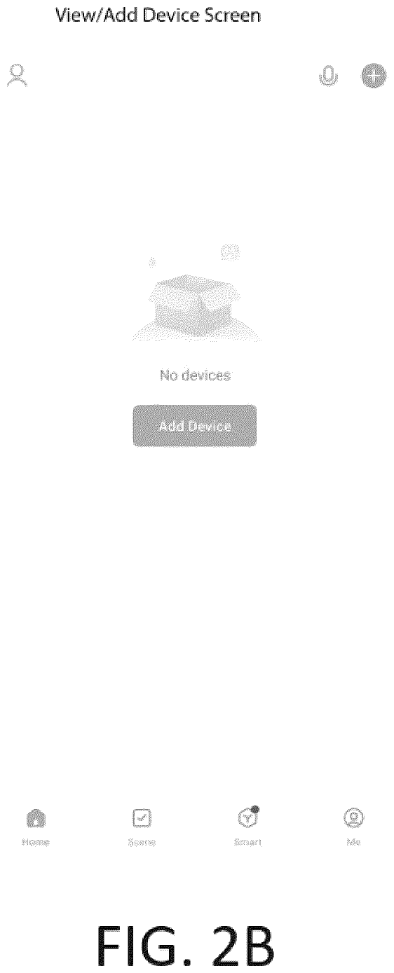

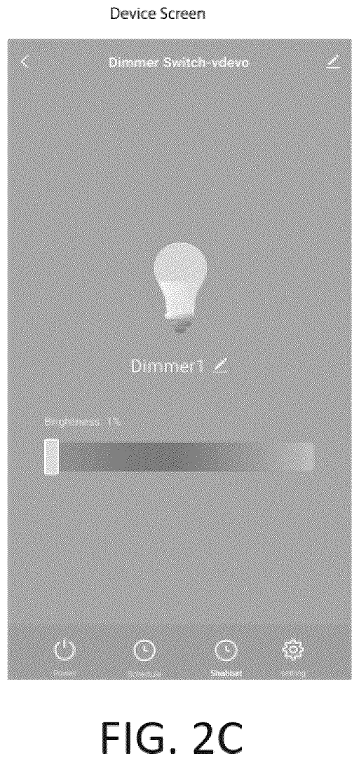

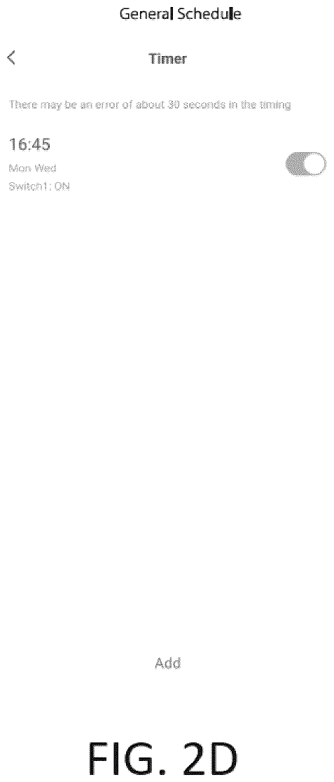

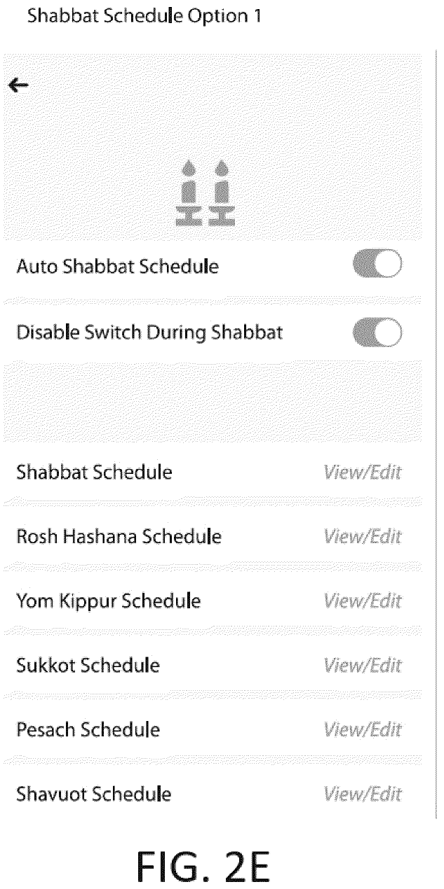

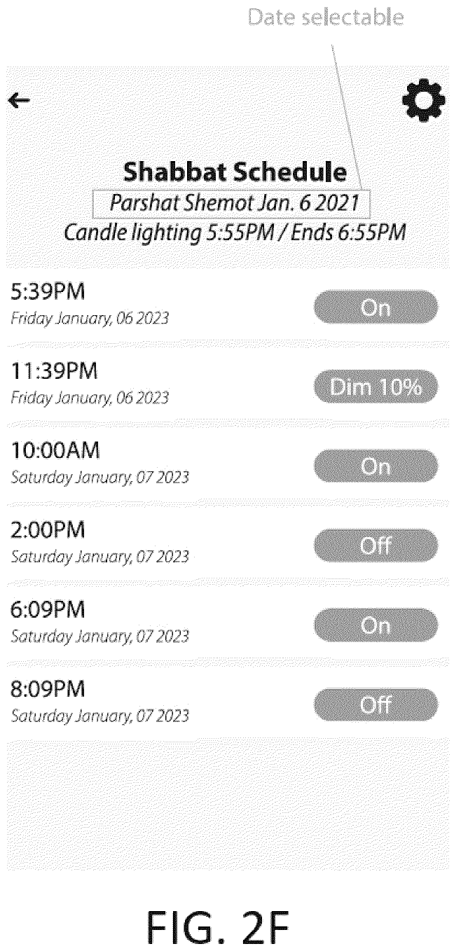

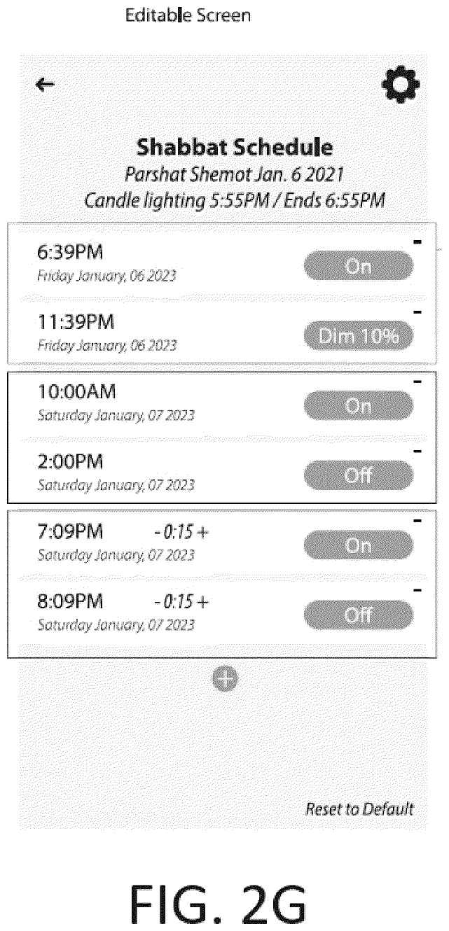

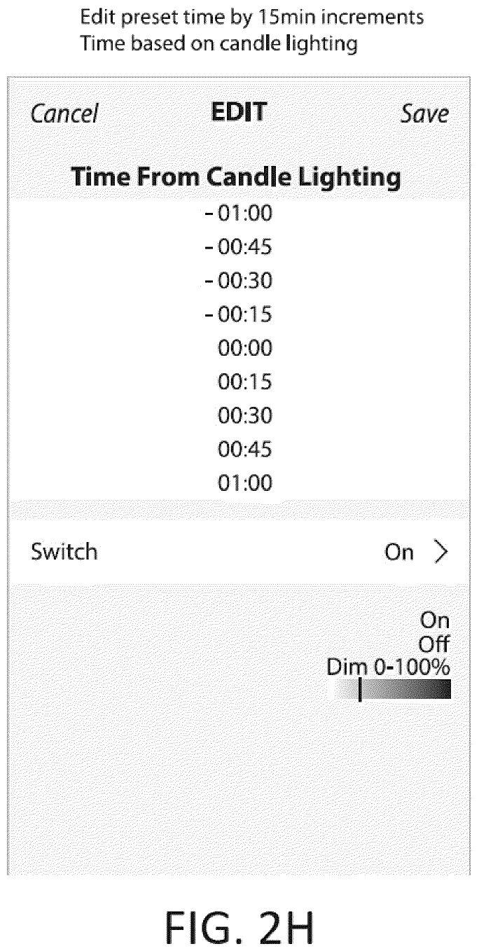

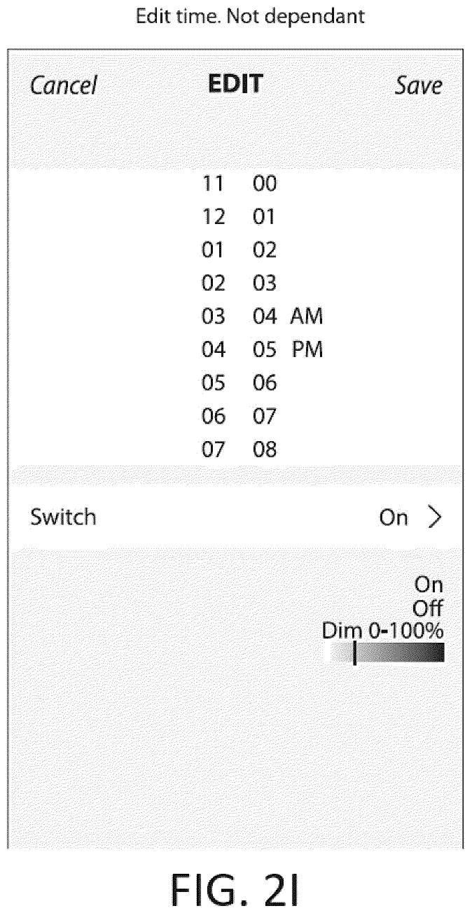

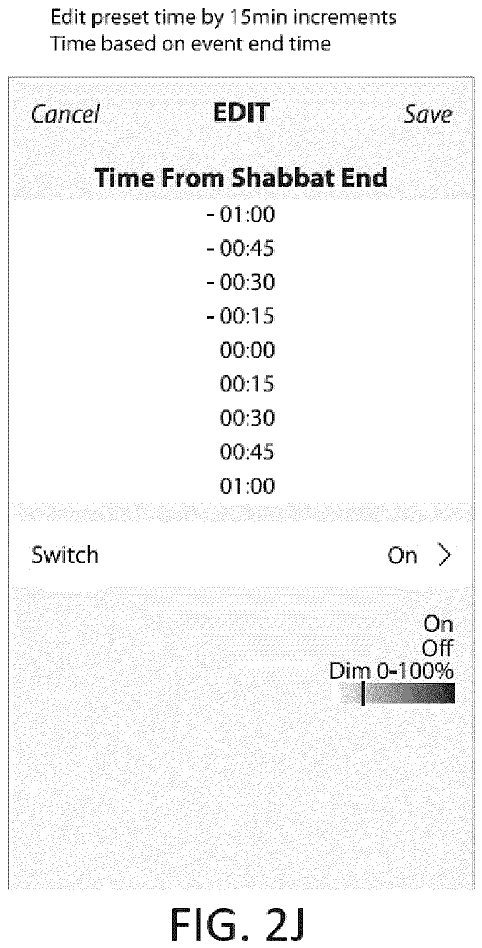

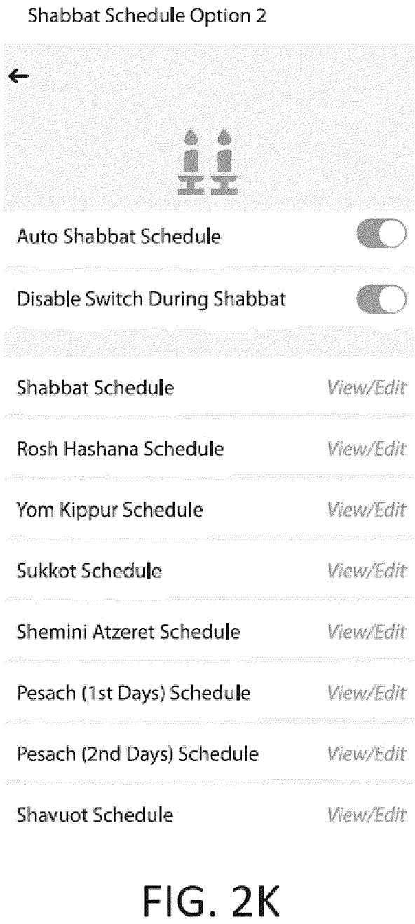

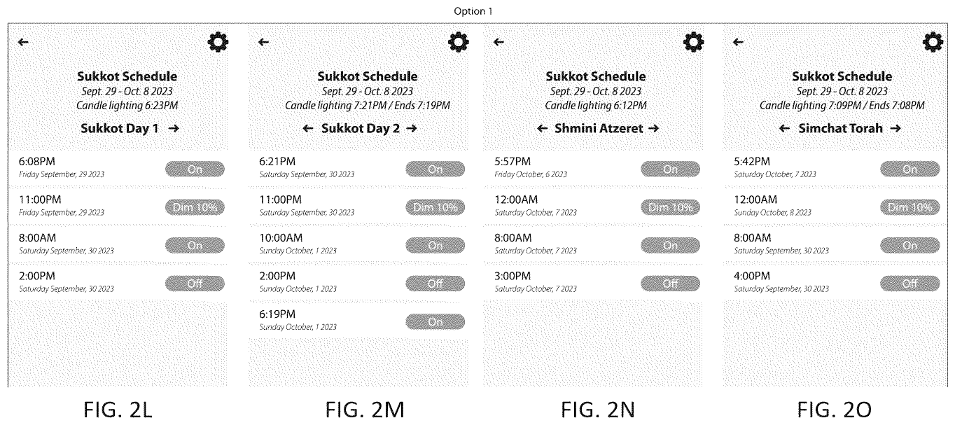

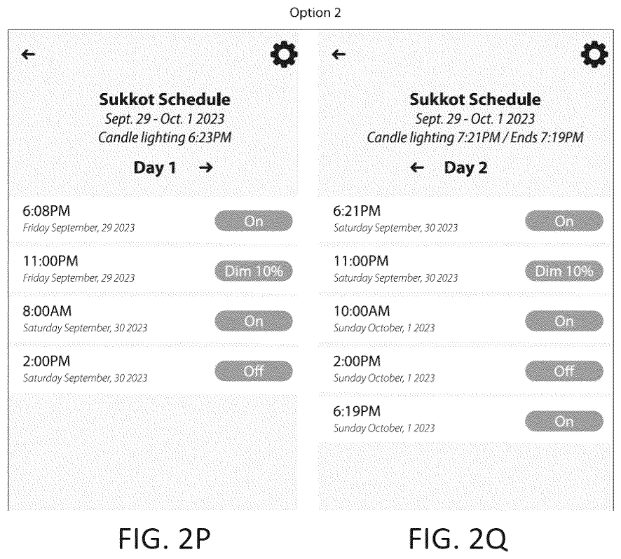

As mentioned earlier, the SmartHome™ Home Automation Program APP is primarily designed for Smart Phones, but can be easily modified to run on separate and remote controller with graphic displays with data input and output capability. FIG. 2A shows a typical initial HOME Login Screen of the SmartHome™ Home Automation Program APP. When first running the Sunlite SmartHome™ Home Automation Program APP, the new user is prompted to select and setup as a New User. Once the user setup is completed, the user can simply login to their user account using their username and a password created during the initial setup as a New User. Multiply users can be setup and each user will have to select their user login credentials, or only a single user may be setup one at a time at which case, the previous user will have to logout of their respective accounts before the new user can login to their account using their unique username and password.

FIG. 2B shows the View/Add Device Screen of the SmartHome™ Home Automation Program APP. This screen will show all devices to be controlled that will be added or have already been added to the application remote cloud database, or the user can Add Device if No devices have been previously added. On the bottom of the Device Screen, there is a Menu of four icon buttons. Starting from the bottom left corner and moving to the right corner. The first icon is a HOME icon button to go back to the first HOME LOGIN SCREEN. The second icon is a Scene button that will allow the user to Group Devices together and allow the Groups of Devices to perform different pre-programmed canned looks or scenes based on defined times, settings, and durations. The third icon is a Smart button that connects to TUYA available features including Cloud Storage, Message Notification, or Phone Notification, etc. Lastly, the fourth icon is a ME icon button or User Profile page that stores the entered data to create a profile of the user of the custom SmartHome™ Home Automation Program APP.

Clicking on any Device added at the VIEW/ADD DEVICE SCREEN will take the user to a third display screen linked to each particular Smart device. FIG. 2C shows the Device Screen of the selected device or group of devices of the SmartHome™ Home Automation Program APP. In this example, Dimmer1 takes the user to a DEVICE SCREEN with the Name of the Device on the Top Heading with an EDIT icon button on the top right corner and a BACK icon button on the top left corner to return to the previous VIEW/ADD DEVICE SCREEN. In this screen, Dimmer1 is shown with a Brightness adjustment slider that can be moved from 1% or lowest intensity up to 100% or full intensity. On the bottom of the Device Screen, there is also a Menu of four icons. Starting from the bottom left corner and moving right. Hitting the first POWER icon button toggles Dimmer1 from OFF to the preset Brightness level set on the adjustment slider from 1% up to 100% intensity.

The second SCHEDULE icon button on the bottom of the Device Screen in FIG. 2B will take the user to a GENERAL SCHEDULE Timer setup screen that will allow general ON/OFF/DIM setting for the various Smart Devices connected to the SmartHome™ Home Automation Program APP. FIG. 2D shows the General Schedule Timer setup screen of the SmartHome™ Home Automation Program APP. On the bottom of this window is an ADD button that will allow the user to add additional days and times for the particular Device selected. When done with the GENERAL SCHEDULE Timer screen, hit the top left return button to go back to the Device Screen for FIG. 2B for the particular Device selected for additional scheduling and settings.

The third SHABBAT icon button on the bottom of the Device Screen in FIG. 2B will take the user to a FIG. 2E SCHEDULE OPTION 1 or a FIG. 2K SCHEDULE OPTION 2 screen. These two screens allow for additional detailed timer programming schedules of Shabbat and other Jewish Holidays and Special Events. The user can select the Auto Shabbat Schedule in which case all timer schedules including Candle Lighting dates and times automatically from the GPS/Geographical Halachic Zmanim data websites based on the user's location as entered in the Smart TUYA setup icon button or in the Me profile setup icon button both in the second display screen bottom menu icon buttons described earlier. In other words, when the Auto Shabbat Schedule icon button is selected to ON, the times are automatically set by the Zmanim API based on the geographical location of the user and zip code. In this enabled ON setting, the GENERAL SCHEDULE Timer of FIG. 2D is disabled, and the subsequent Shabbat and other Jewish holiday event schedules can be Viewed and Edited or left to take the Zmanim API defaults. When the Auto Shabbat Schedule is disabled or set to OFF, only the GENERAL SCHEDULE Timer settings of FIG. 2D are Active, i.e., all Jewish preset schedules are disabled.

FIG. 2E shows the Shabbat Schedule Option 1 screen of the SmartHome™ Home Automation Program APP. SCHEDULE OPTION 1 gives the user access to an Auto Shabbat Scheduling on/off option, and a Disable Device During Shabbat on/off option to prevent accidentally turning on/off a programmed Device. In this window, the user can also View/Edit a Shabbat Schedule; a Rosh Hashana Schedule; a Yom Kippur Schedule; a Sukkot Schedule; a Pesach Schedule; and a Shavuot Schedule.

When a user selects the Shabbat Schedule View/Edit selection button on either the FIG. 2E SHABBAT SCHEDULE OPTION 1 or the FIG. 2K SHABBAT SCHEDULE OPTION 2 display screens, the user will be taken to an EDITABLE SCREEN for that particular Device Shabbat Schedule. FIG. 2F shows the Date Selectable Shabbat Schedule screen of the SmartHome™ Home Automation Program APP for Shabbat Schedule Option 1 or Shabbat Schedule Option 2 when selected.

From the Zmanim API websites, the data for Occasions or Events like Parshat Shemot for example, the Date, and the actual Candle Lighting Start and End times are displayed. FIG. 2G shows the Editable Screen for the Shabbat Schedule of the SmartHome™ Home Automation Program APP for Shabbat Schedule Option 1 or Shabbat Schedule Option 2 when selected.

The user can then add start times, end times, and actions for each particular Device or Group of Devices in EDIT display screens in preset times by 15-minute increments with editable times based on default Candle Lighting times. FIG. 2H shows the Edit screen for the Time from Candle Lighting with 15-minute increment preset times based on the Candle Lighting time of the SmartHome™ Home Automation Program APP for Shabbat Schedule Option 1 or Shabbat Schedule Option 2 when selected. Or, the user can add or edit or delete the times and actions independent of the default Candle Lighting times. FIG. 2I shows the independent Edit Time screen of the SmartHome™ Home Automation Program APP for Shabbat Schedule Option 1 or Shabbat Schedule Option 2 when selected. Or, the user can then add start times, end times, and actions for each particular Device or Group of Devices in EDIT display screens in preset times by 15-minute increments with editable times based on time from Shabbat ending. FIG. 2J shows the Edit screen for the Time from Shabbat End with 15-minute increment preset times based on the event end time of the SmartHome™ Home Automation Program APP for Shabbat Schedule Option 1 or Shabbat Schedule Option 2 when selected.

The same features are also available for the other Jewish holidays and special events with editable days and times besides the default Candle Lighting, independent of the Candle Lighting times, and default Event end times automatically set by the Zmanim API websites when the Auto Shabbat Schedule is selected in the Shabbat Schedule Option 1 including, but not limited to Rosh Hashana, Yom Kippur, Sukkot, Pesach, and Shavuot.

FIG. 2K shows the Shabbat Schedule Option 2 screen of the SmartHome™ Home Automation Program APP. SCHEDULE OPTION 2 is similar to SCHEDULE OPTION 1 with additional scheduling options. Like before, SCHEDULE OPTION 2 gives the user access to an Auto Shabbat Schedule option for on/off, and a Disable Device During Shabbat option for on/off. In this window, the user can View/Edit a Shabbat Schedule; a Rosh Hashana Schedule; a Yom Kippur Schedule; a Sukkot Schedule; a Shemini Atzeret Schedule; a Pesach (1^{st} Days) Schedule; a Pesach (2^{nd} Days) Schedule; and a Shavuot Schedule.

When a user selects the Shabbat Schedule View/Edit selection button on the FIG. 2K SHABBAT SCHEDULE OPTION 2 display screen, the user will be taken to an EDITABLE SCREEN for that particular Device Shabbat Schedule similar to FIG. 2F showing the Date Selectable Shabbat Schedule screen of the SmartHome™ Home Automation Program APP for Shabbat Schedule Option 2 when selected.

From the Zmanim API websites, the data for Occasions or Events like Parshat Shemot for example, the Date, and the actual Candle Lighting Start and End times are displayed similar to FIG. 2G that shows the Editable Screen for the Shabbat Schedule of the SmartHome™ Home Automation Program APP for the Shabbat Schedule Option 2 when selected.

The user can then add start times, end times, and event actions for each particular Device or Group of Devices in EDIT display screens in preset times by 15-minute increments with editable times based on default Candle Lighting times. Similarly, FIG. 2H shows the Edit screen for the Time from Candle Lighting with 15-minute increment preset times based on the Candle Lighting time of the SmartHome™ Home Automation Program APP for Shabbat Schedule Option 2 when selected. Or, the user can add or edit or delete the times and actions independent of the default Candle Lighting times. FIG. 2I shows the independent Edit Time screen of the SmartHome™ Home Automation Program APP for Schedule Option 2 when selected. Or, the user can then add start times, end times, and actions for each particular Device or Group of Devices in EDIT display screens in preset times by 15-minute increments with editable times based on time from Shabbat ending. FIG. 2J shows the Edit screen for the Time from Shabbat End with 15-minute increment preset times based on the event end time of the SmartHome™ Home Automation Program APP for Shabbat Schedule Option 2 when selected.

The same features are also available for the other Jewish holidays and special events with editable days and times besides the default Candle Lighting, independent of the Candle Lighting times, and default Event end times automatically set by the Zmanim API websites when the Auto Shabbat Schedule is selected in Shabbat Schedule Option 2 including, but not limited to Rosh Hashana, Yom Kippur, Pesach (1^{st} Days), Pesach (2^{nd} Days), and Shavuot.

In the FIG. 2K Shabbat Schedule Option 2 screen, the Sukkot Scheduling can be further broken down into an additional detailed Option 1 for Sukkot Day 1 and Sukkot Day 2, and into Shemini Atzeret and Simchat Torah inclusive event dates including Candle Lighting Times, and Candle Lighting and Candle End Times respectively. FIG. 2L shows the Sukkot Schedule Day 1 Option 1 screen of the SmartHome™ Home Automation Program APP for the Shabbat Schedule Option 2. FIG. 2M shows the Sukkot Schedule Day 2 Option 1 screen of the SmartHome™ Home Automation Program APP for the Shabbat Schedule Option 2. FIG. 2N shows the Shmini Atzeret Option 1 screen of the SmartHome™ Home Automation Program APP for the Shabbat Schedule Option 2. FIG. 2O shows the Simchat Torah Option 1 screen of the SmartHome™ Home Automation Program APP for the Shabbat Schedule Option 2.

Lastly, in the FIG. 2K Shabbat Schedule Option 2 screen, the Sukkot Scheduling can be broken down into an additional basic Option 1 for Sukkot Day 1 and Sukkot Day 2 including Candle Lighting Times, and Candle Lighting and Candle End Times respectively. FIG. 2P shows the Sukkot Schedule Day 1 Option 2 screen of the SmartHome™ Home Automation Program APP for the Shabbat Schedule Option 2. FIG. 2Q shows the Sukkot Schedule Day 2 Option 2 screen of the SmartHome™ Home Automation Program APP for the Shabbat Schedule Option 2.

FIG. 2R shows an additional or alternate screen similar to the Device Screen of FIG. 2C that may be used in the SmartHome™ Home Automation Program APP. Operation is similar to the functions described for FIG. 2C, but this display screen includes icon buttons for Planning events, scheduling events, setting times to the events, connecting and synching with Biorhythm data, Power-On behavior, dimming, etc. among many other available options and features that may be included in the SmartHome™ Home Automation Program APP.

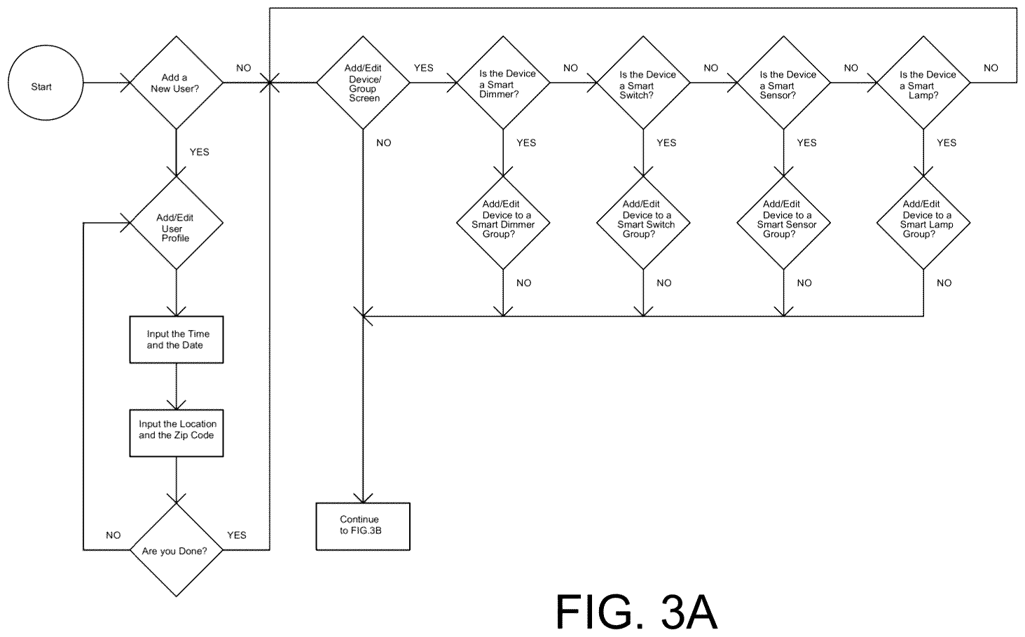

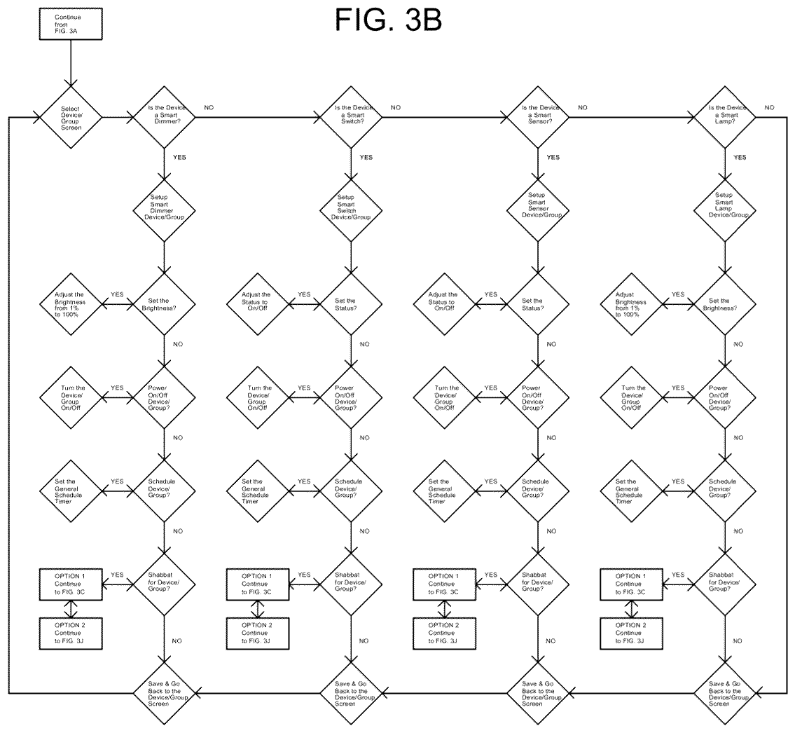

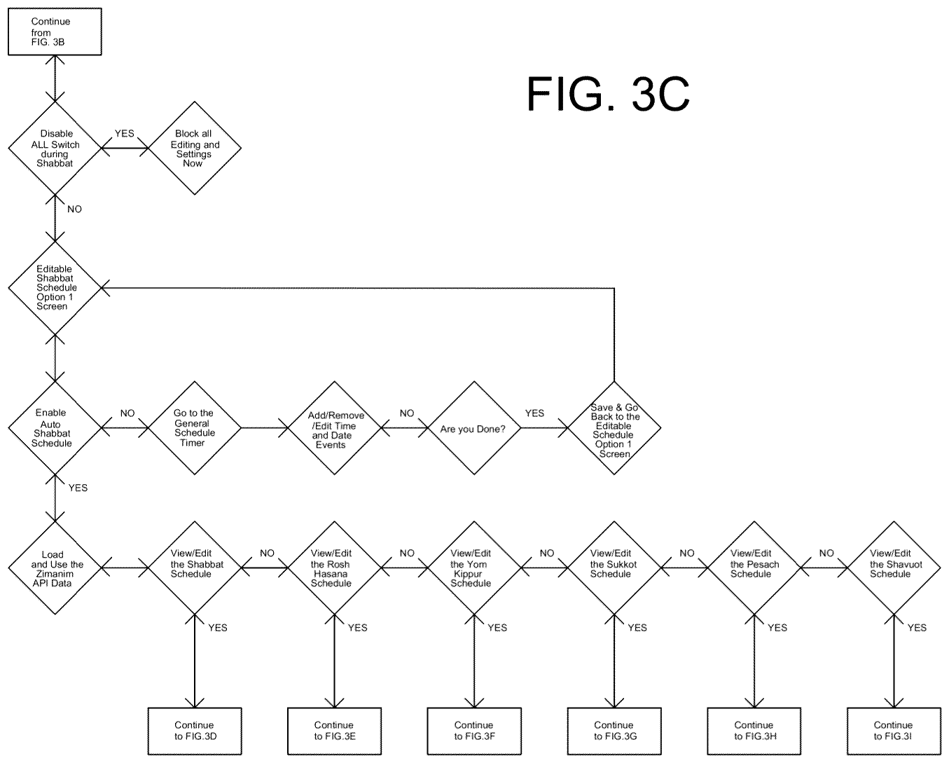

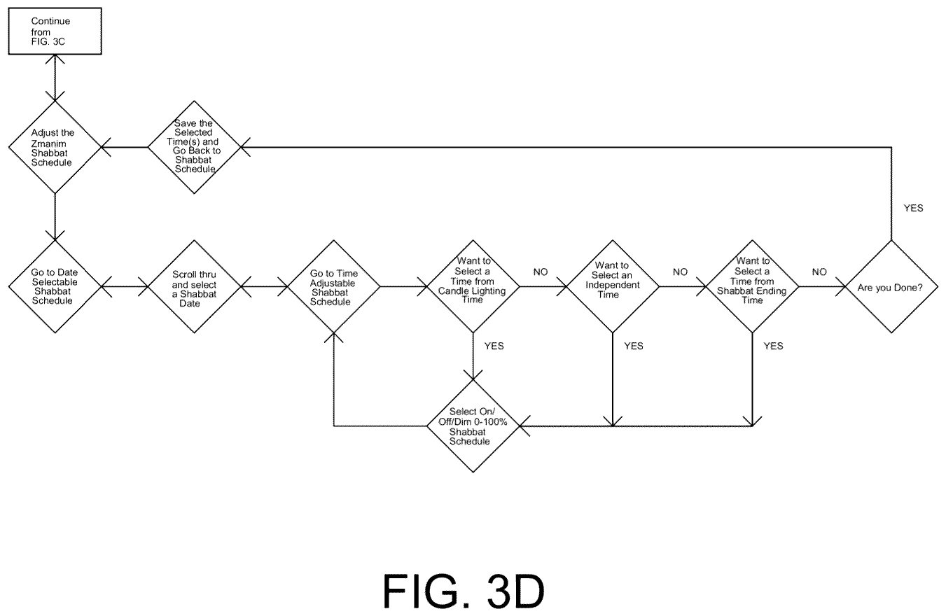

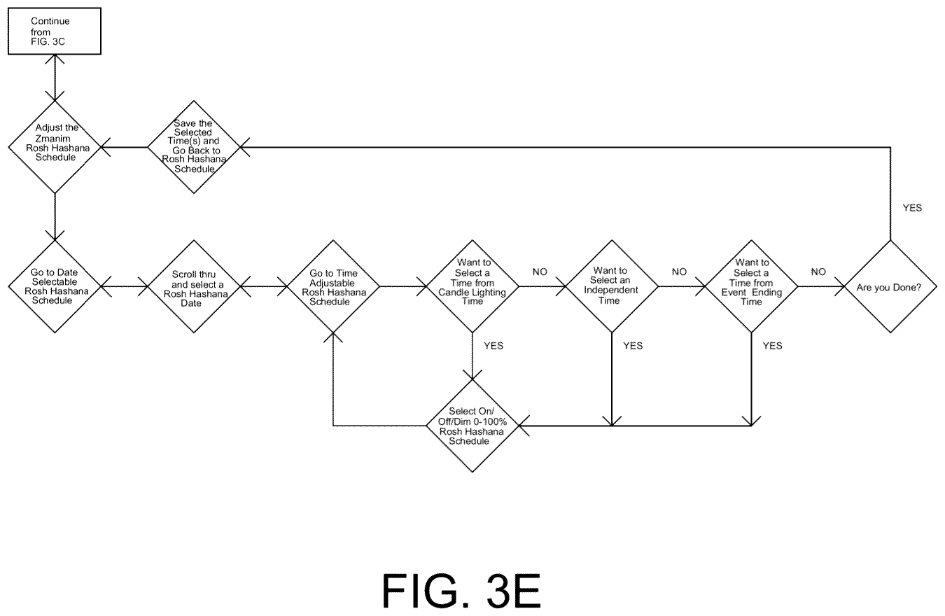

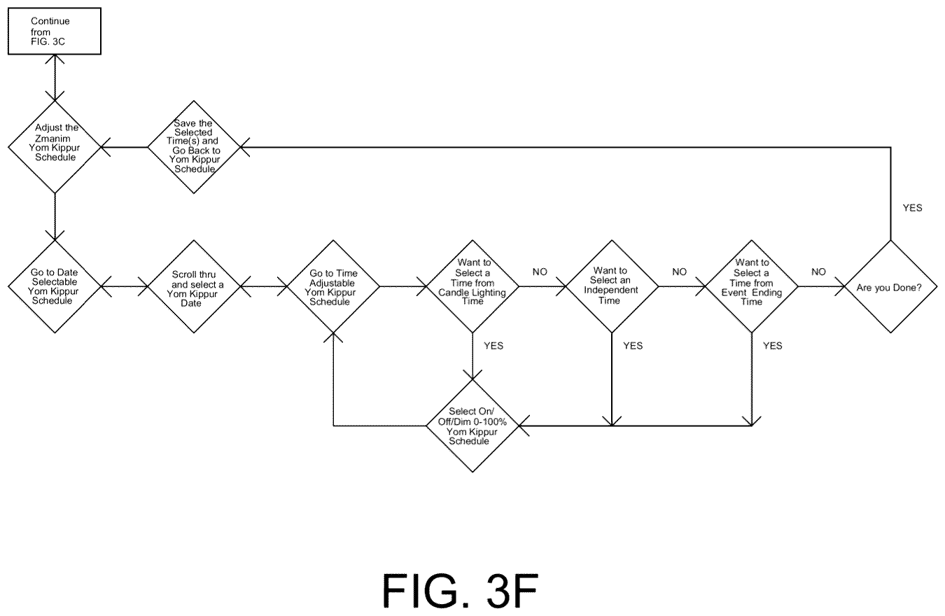

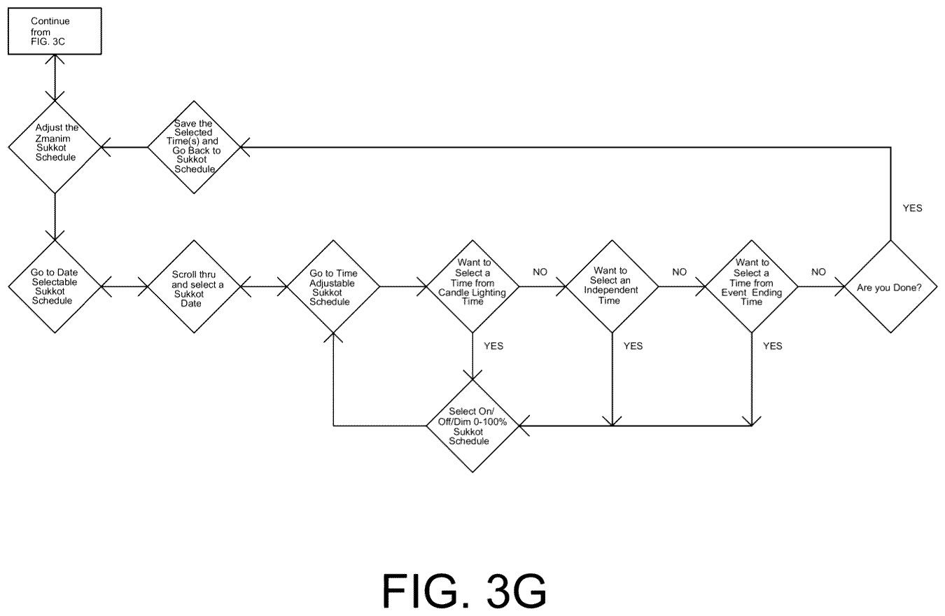

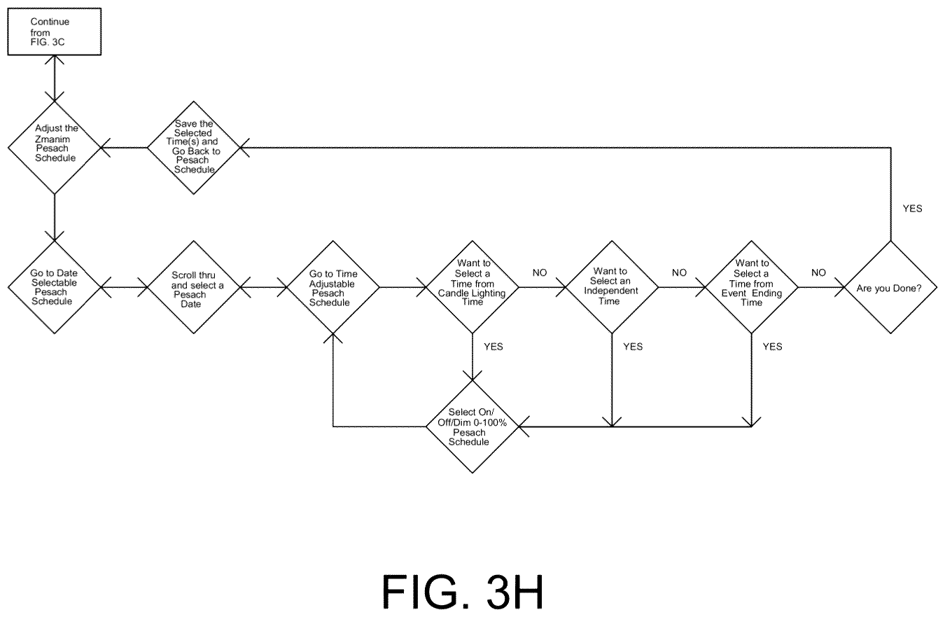

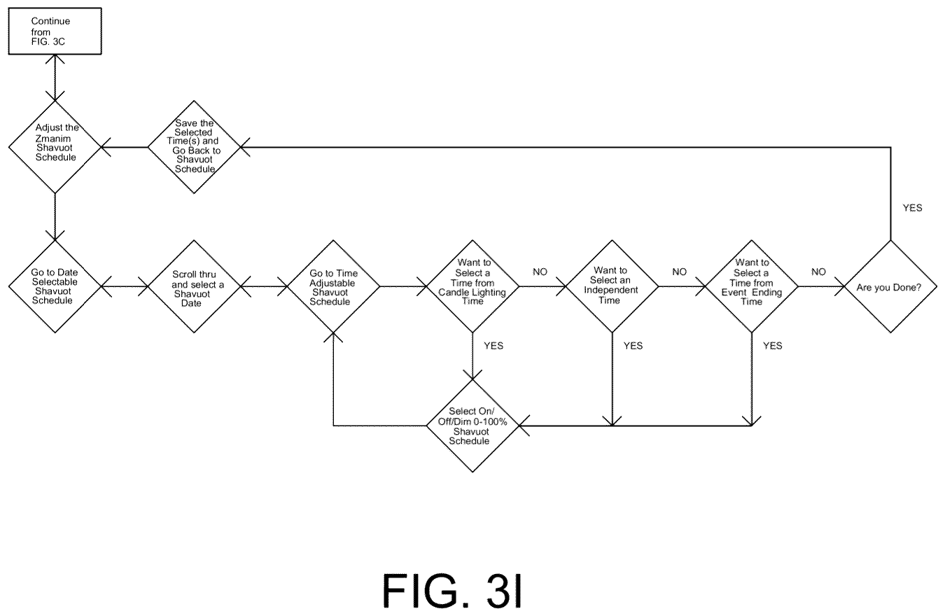

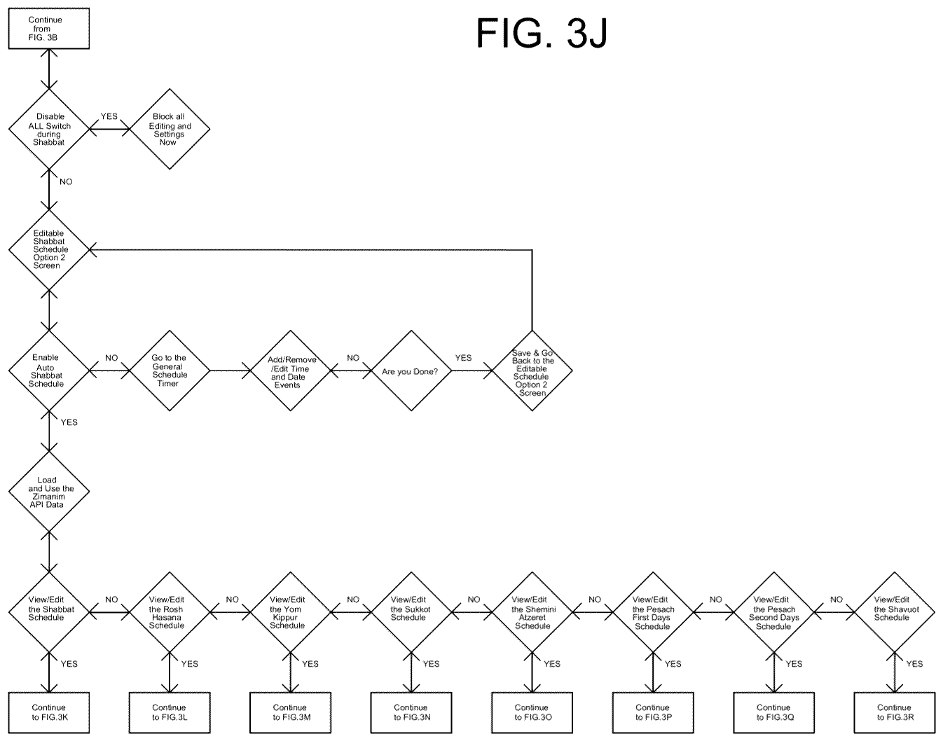

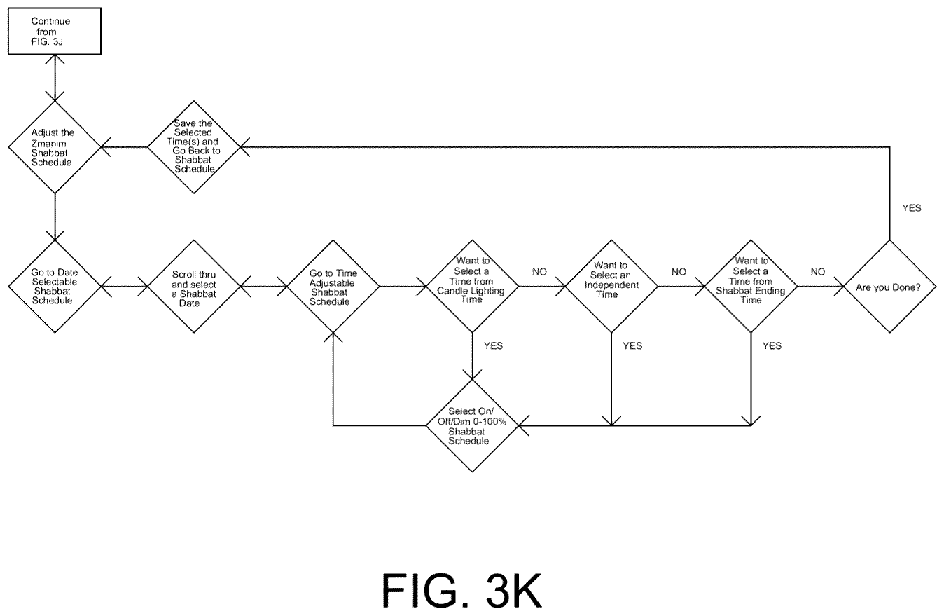

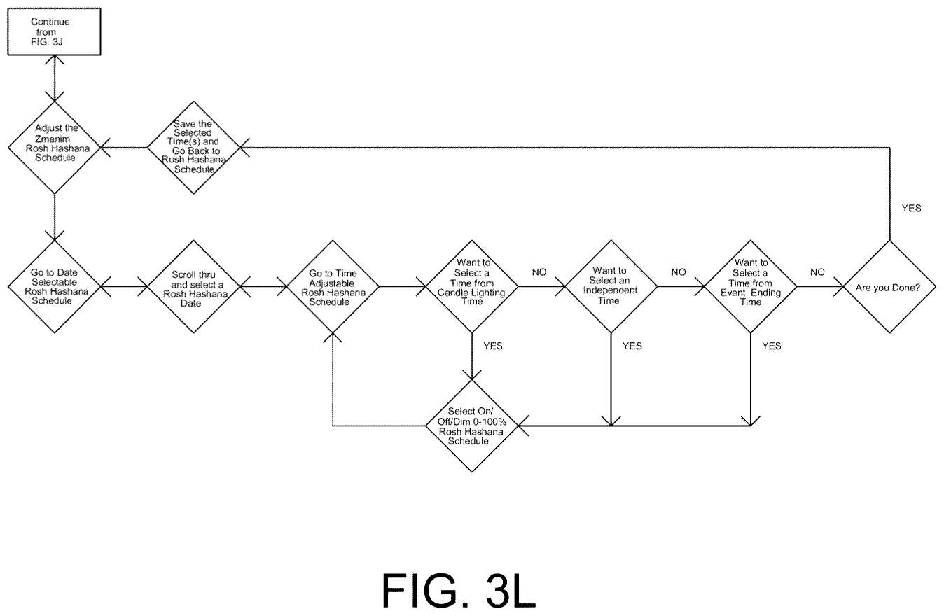

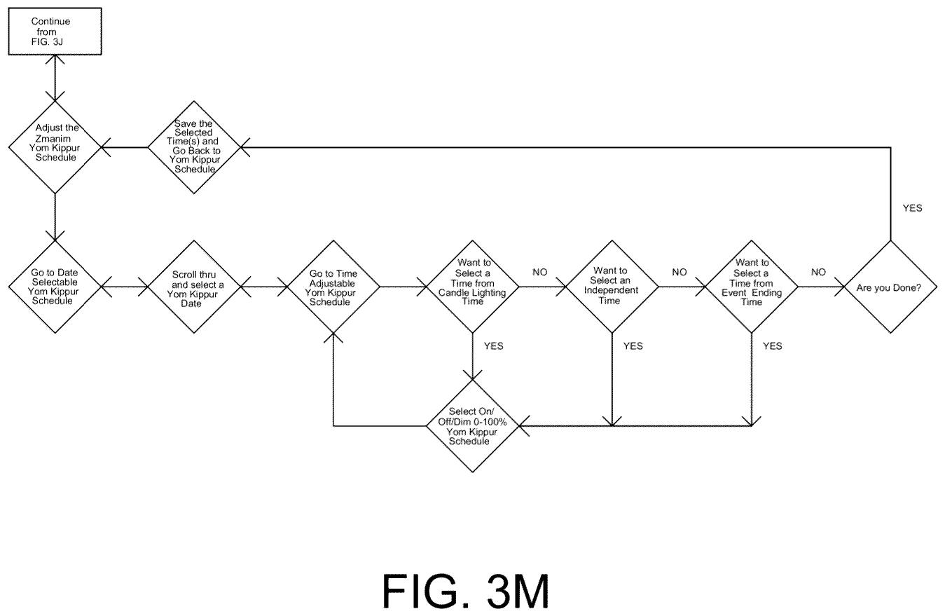

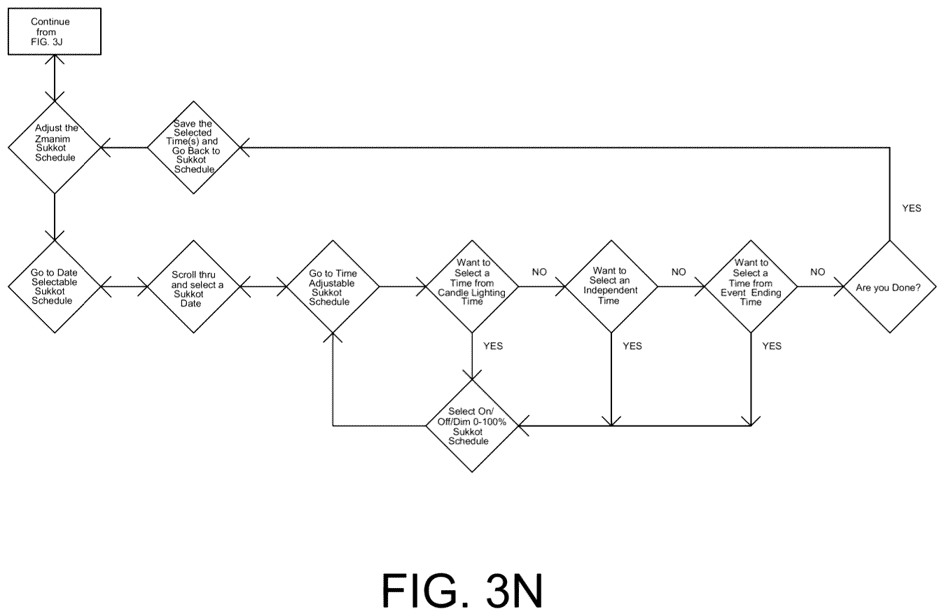

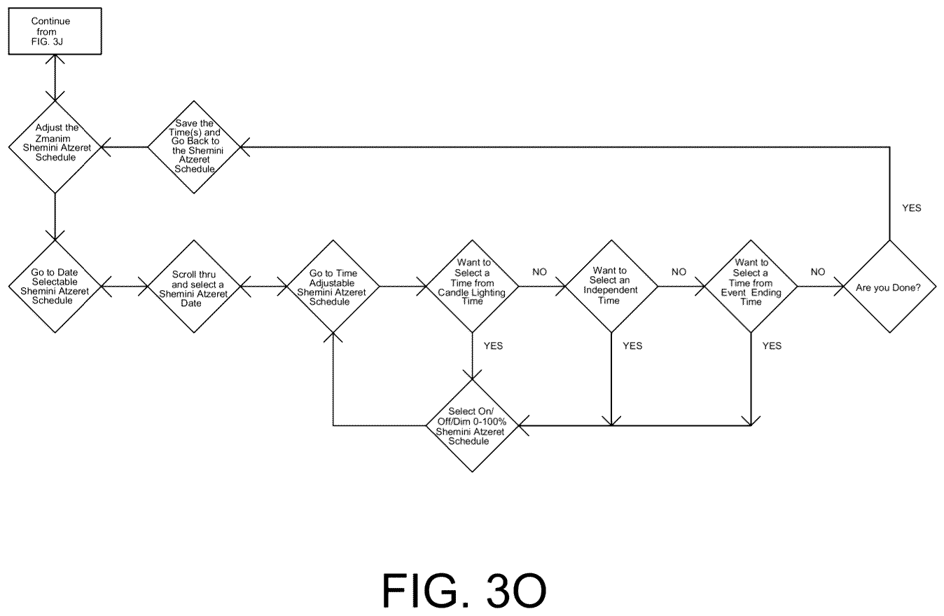

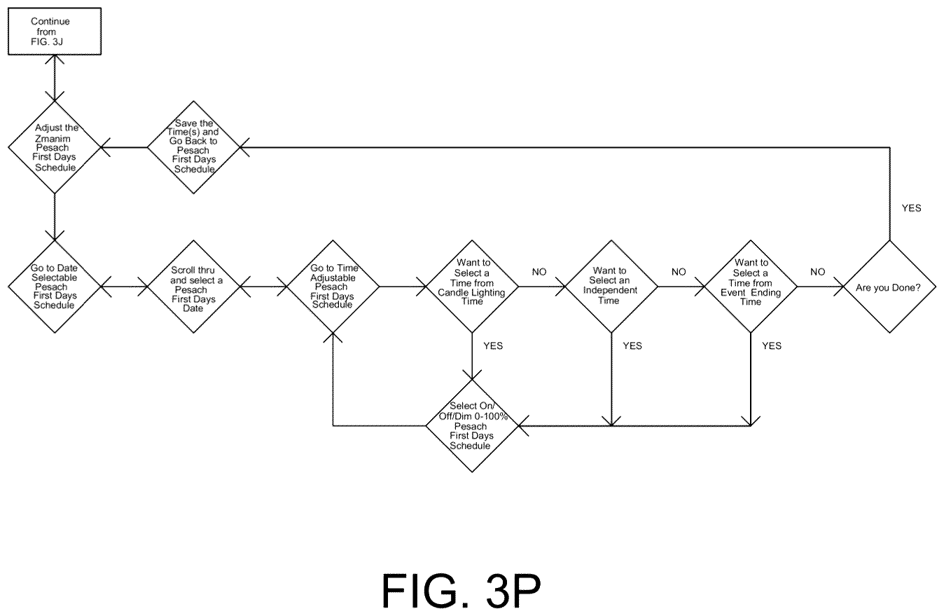

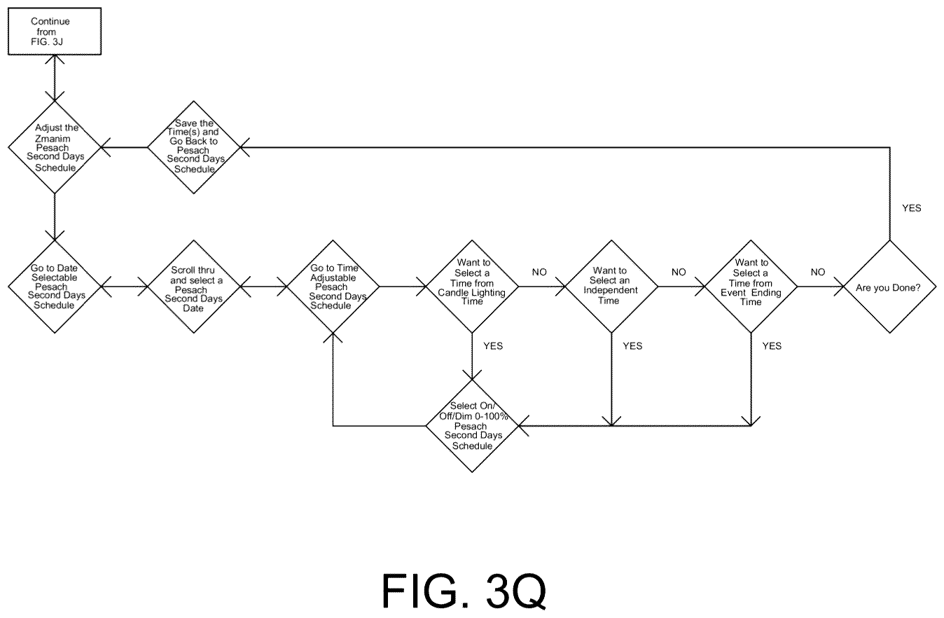

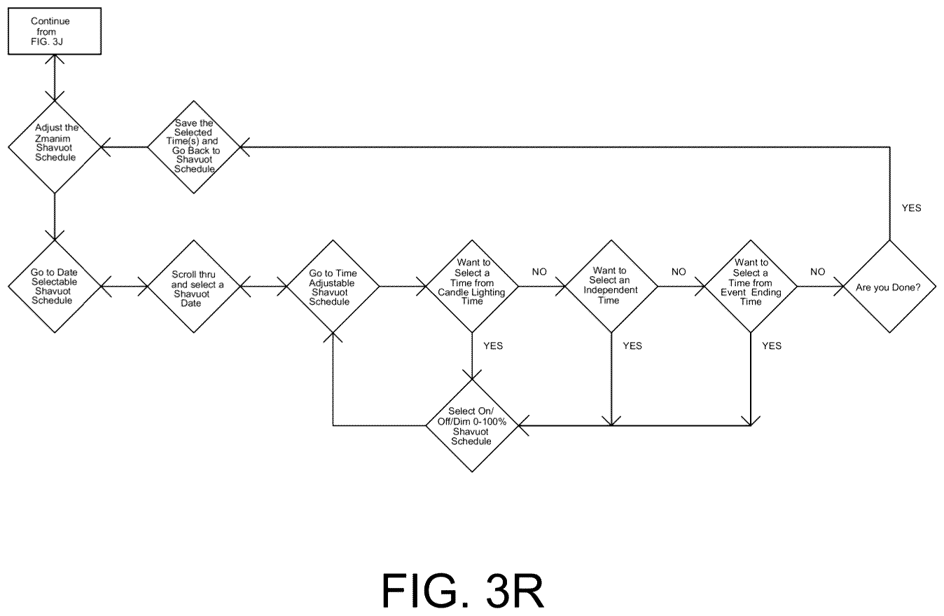

FIGS. 3A to 3R are self-explanatory and show the various Mode Selection Process Flowcharts for the different embodiments of the SmartHome™ System including the SmartHome™ Home Automation Program APP and Smart Devices designed to work together easily in the adding, editing, and deleting of Shabbat and other special holidays and event dates, times, and actions, all while adhering to the Jewish culture and laws.

Other programmable features not described in detail and not shown here may include: Normal Weekday programming functions including ON/OFF; Dimming from 1% to 100%; Selectable Color-Tuning at 2700K, 3000K, 3500K, 4000K, and 5000K color temperatures; and Voice Command Control and AI interfacing with Amazon Alexa, Google Assistant, AliGenie, DuerOS, Tencent Xiaowei, Tencent Dingdan, etc.

For Shabbos/Yom Tov function, the SmartHome™ Home Automation Program APP will automatically link to Zmanim and at Shabbat Candle Lighting, a user can setup and plan different scenes for example, to dim light to a user determined percentage or to remain full ON at 100%, and adjust the color temperature, turn OFF lights after a user determined time in hours and minutes, and then turn back ON the lights at a user determined time of the day, etc.

Lastly, other capabilities of the SmartHome™ Home Automation Program APP program and may include synching with Biorhythm lighting that is special lighting used to connect and synchronize with the recurring cycle in the physiology or functioning of living organism such as the daily Circadian rhythm of human sleeping and waking cycles; APP data memory retention during an emergency power failure condition and Power-on behavior, Do-Not-Disturb settings, and Cycle and Zmanim Timings, some of which are briefly shown in FIG. 2R.

It will be understood that various changes in the details, materials, types, values, processes, modes, system flow, programming, and arrangements of the system components that have been described and illustrated in order to explain the nature of this invention may be made by those skilled in the art without departing from the principle and scope of the invention as expressed in the following claims. Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A smart lighting home automation control system, comprising:
a portable controller and monitoring apparatus,
a software program running in said portable controller and monitoring apparatus designed to enable observant Jewish individuals to manage building and household lighting fixtures and devices during religious holidays, and
an apparatus and methods for controlling said lighting fixtures and devices in accordance with Jewish law under control of said software program.

2. The smart lighting home automation control system of claim 1, further including:
the generation of regular schedules based on the Jewish calendar and rules of Jewish religious activities,
the creation of special schedules for specific needs or activities, and
allowing manual selection between regular and special schedules for said lighting fixtures and devices.

3. The smart lighting home automation control system of claim 2,
wherein said portable controller and monitoring apparatus is a cellular smart phone, and
wherein said software program integrates Zemanim schedule information and user location data to set preferences for said lighting fixtures and devices performance before and after Shabbat or Yom Tov, and
ensuring energy savings and optimal lighting features in a Kosher home.

4. The smart lighting home automation control system of claim 3,
wherein the said software program is a SmartHome® Home Automation Program APP installed in said cellular smart phone.

5. The smart lighting home automation control system of claim 1, further including:
an internal clock set in said software program,
wherein said internal clock is automatically synchronized with the National Bureau of Standards atomic clock and updates set schedules at preset intervals and reports updated schedules to said remote monitoring system, and
enhances the efficiency and accuracy of the smart lighting home automation system.

6. The smart lighting home automation control system of claim 1, further including:
overriding of normal mode functionality with holiday mode at the beginning of Jewish holidays,
automatically setting on/off times based on Zmanim API data, and
providing user-friendly interfaces for scheduling Shabbat, Jewish holidays, and special events with editable times and actions for said lighting fixtures and devices.

7. The smart lighting home automation control system of claim 1, further including:
normal weekday programming functions,
dimming capabilities,
color-tuning options,
voice command control,
AI interfacing,
synching with human biorhythms,
data memory retention during power failures, and
various timing adjustments for optimal lighting fixture control and user convenience.

8. A method for controlling smart lighting and electrical appliances in a smart lighting home automation control system according to Jewish religious rules comprising:
a software programming application to automatically scheduling the operation of lights and appliances based on the Jewish calendar, and
specific holiday requirements in said software programming application.

9. A method for managing smart devices in the smart lighting home automation control system of claim 8,
wherein said software programming application also allows setting up user accounts with unique login credentials,
allows multiple users to access and control the system, and
enables seamless transitions between user accounts.

10. A method for creating and editing schedules for Shabbat and Jewish holidays in the smart lighting home automation control system of claim 9,
wherein said software programming application further allows selecting auto Shabbat scheduling options, customizing device actions, and
integrating Zmanim API data for accurate timing.

11. A method for configuring lighting and appliance schedules during Shabbat and Jewish holidays in the smart lighting home automation control system of claim 10,
wherein said software programming application also further allows setting start and end times,
adjusting brightness levels, and
defining actions for individual devices or groups of devices based on user preferences and religious requirements.

12. A method for enhancing user experience in a SmartHome® Home Automation Program APP, including:
providing options for dimming lights,
selecting color temperatures,
enabling voice command control, and
interfacing with virtual assistants like Amazon Alexa and Google Assistant for seamless operation.

13. A method for ensuring compliance with Jewish customs and laws in the SmartHome® Home Automation Program APP, of claim 12, further including:
synchronizing with biorhythm lighting,
retaining data during power failures,
setting do-not-disturb preferences, and
adjusting lighting cycles based on Zmanim timings for optimal functionality.

14. A method for controlling building and household lighting fixtures during religious holidays in the SmartHome® Home Automation Program APP, of claim 13 further comprising:
generating regular schedules for on/off times of devices based on the Jewish calendar and rules of Jewish religious activities,
creating special schedules for specific needs or activities, and
allowing manual selection between regular and special schedules for smart devices.

15. A method for operating a SmartHome® Home Automation Program APP comprising:
utilizing Zmanim and user location data to set preferences for device performance before and after Shabbat or Yom Tov,
ensuring energy savings and optimal lighting features in a Kosher home, and automatically synchronizing the clock with the National Bureau of Standards atomic clock.

16. A method for facilitating functionality in accordance with Jewish law in the SmartHome® Home Automation Program APP of claim 15 further comprising:
selecting between normal and holiday modes to fix the state of switches during holidays, storing holiday calendars and detecting local conditions to enhance system operation, and providing user-friendly interfaces for scheduling Shabbat, Jewish holidays, and special events with editable times and actions for smart lighting fixtures and devices.

17. A method for optimizing lighting control and user convenience in the SmartHome® Home Automation Program APP of claim 16 further comprising:
implementing normal weekday programming functions,
dimming capabilities,
color-tuning options,
enabling voice command control,
AI interfacing,
synching with human biorhythms,
retaining data during power failures, and
adjusting timing for optimal lighting based on user preferences.
